(19) United States
(12) Patent Application Publication
(10) Pub. No.: US 2025/0160382 A1
(43) Pub. Date: May 22, 2025

(54) NUTRITIONAL SUPPLEMENT COMPOSITION FOR GERIATRIC POPULATION AND A METHOD OF PRODUCING THE COMPOSITION

(71) Applicant: THINKING FORKS CONSULTING PRIVATE LIMITED, Bangalore (IN)

(72) Inventors: Rinka Banerjee, Bangalore (IN); Aditya Sapru, Bangalore (IN); Meera Srinivasan, Chennai (IN); R. G. Raja Rajan, Bangalore (IN)

(21) Appl. No.: 18/286,220

(22) PCT Filed: Mar. 3, 2022
(86) PCT No.: PCT/IN2022/050188

§ 371 Date: Oct. 9, 2023

(30) Foreign Application Priority Data
Mar. 12, 2021 (IN) 202141010605

(51) Int. Cl. A23L 33/00; A23L 2/39; A23L 2/56; A23L 2/58; A23L 2/60; A23L 2/66; A23L 33/115; A23L 33/125; A23L 33/155; A23L 33/16; A23L 33/175; A23L 33/185; A23L 33/19; A23L 33/21; A23P 10/20

(52) U.S. Cl. CPC A23L 33/40; A23L 2/39; A23L 2/56; A23L 2/58; A23L 2/60; A23L 2/66; A23L 33/115; A23L 33/125; A23L 33/155; A23L 33/16; A23L 33/175; A23L 33/185; A23L 33/19; A23L 33/21; A23P 10/20

(57) ABSTRACT

The present disclosure provides a nutritional supplement composition for the geriatric population and a method of producing the nutritional supplement composition. The nutrient supplement composition includes about, 18%-34% w/w of at least one carbohydrate source, 48%-57% w/w of the at least one protein source, (iii) 8%-21% w/w of at least one dietary fiber; (iv) 5%-9% w/w of the at least one fat source, (v) 4.0% w/w of the mineral premix, and (vi) 0.16% w/w of the vitamin premix.

### BACKGROUND

### Technical Field

The present disclosure relates generally to nutrient compositions, and more particularly, the present disclosure relates to a nutrient supplement composition, specifically for the geriatric population, and a method of producing the nutrient supplement composition.

### Description of the Related Art

Good nutrition is essential for keeping people healthy across their lifespans. Poor dietary habits and lifestyle are the major reasons which fuel non-communicable diseases (NCDs) and certain chronic health problems. A healthier diet can help to reduce the risk of NCDs. Elderly people are more likely to suffer from chronic than acute illnesses. Multiple chronic diseases afflict them such as chronic bronchitis, anemia, bone diseases, high blood pressure, chest pain, kidney problems, digestive disorders, vision problems, diabetes, rheumatism, and depression.

Healthy eating may help people with chronic diseases or NCDs to manage these conditions and prevent complications. However, an unbalanced diet of elderly people may not fulfill the changing needs of their bodies and continue to lack essential nutrients like protein and fiber. With reduced absorption ability, micronutrient deficiencies (e.g., Iron, Calcium, B12) are also rampant among elderly people.

The world has been experiencing a demographic shift since the pace of population aging around the world is increasing dramatically. As per the world health organization (WHO) report, between 2015 and 2050, a proportion of the world's population over 60 years will nearly double from 12% to 22%. In about five years, people aged 60 years and older will outnumber children younger than 5 years. In 2019, the number of people aged 60 years and older was about 1 billion. This number will increase to 1.4 billion by 2030 and 2.1 billion by 2050. By 2050, 80% of all older population will live in low and middle-income countries. Both increases in the proportion of the elderly people and life expectancy throughout the world may be a hidden burden as this increase, unfortunately, is not a ‘healthy life expectancy.

The increasing significance of the non-communicable diseases (NCDs) burden suggests a need for serious intervention strategies to prevent the NCDs burden for the elderly people. A challenge would be to implement appropriate prevention strategies to halt the growing trend in the NCDs against a background of infectious diseases. For example, in the Covid19 pandemic, the population above 60 years with or without comorbidities due to NCDs is more likely to be affected. Elderly people experience decreased or no muscle response for the nutrients consumed by dietary means. Hence, nutrition supplements help to realize an ideal quantity of nutrient intake per day.

Existing nutritional beverage products are limited and expensive and not necessarily with the optimum nutrition and ingredient profile for elderly people. Addressing the nutritional needs of the elderly people in a sustained manner, in a convenient format will help to reduce the gap between life expectancy and healthy life expectancy, which can reduce the economic and health care burden of a country.

Therefore, there arises a need to address the aforementioned technical drawbacks in existing products in satisfying the nutritional needs of the geriatric population.

### SUMMARY OF THE INVENTION

In view of the foregoing, a nutritional supplement composition with a recommended nutrient profile for the geriatric population is provided. The composition includes at least one carbohydrate source. The composition includes at least one protein source. The protein source includes at least one essential amino acid. The composition includes at least one dietary fiber, at least one fat source, a mineral premix, and a vitamin premix. The composition includes about 18%-34% w/w of at least one carbohydrate source, 48%-57% w/w of the at least one protein source, 8%-21% w/w of at least one dietary fiber. The composition includes 5%-9% w/w of at least one fat source, 4.0% w/w of the mineral premix, and 0.16% w/w of the vitamin premix.

In some embodiments, the composition includes about (i) 27%-34% w/w of at least one carbohydrate source, (ii) 49%-57% w/w of the at least one protein source; (iii) 8%-12% w/w of the at least one dietary fiber, (iv) 6%-9% w/w of the at least one fat source, (v) 4.0% w/w of the mineral premix, and (vi) 0.16% w/w of the vitamin premix.

In some embodiments, the composition includes about (i) 18%-22% w/w of at least one carbohydrate source, (ii) 48%-56% w/w of the at least one protein source, (iii) 14.7%-21% w/w of the at least one dietary fiber, (iv) 5%-8% w/w of the at least one fat source, (v) 4% w/w of the mineral premix, and (vi) 0.16% w/w of the vitamin premix.

In some embodiments, the composition includes 0.08% w/w of a sweetener. The sweetener is stevia.

In some embodiments, the composition includes 0.5% w/w of a coloring agent. The coloring agent is selected from turmeric powder, beetroot, caramel, annatto.

In some embodiments, the composition includes 0.5%-2% w/w of at least one flavoring agent. The flavoring agent is a natural flavoring agent, nature-identical flavoring agent, or artificial flavoring agent. The natural flavoring agent is selected from a badam powder, Kesar badam powder, cardamom powder, saffron powder.

In some embodiments, the composition includes 0.1%-0.7% w/w of stabilizer. The stabilizer is selected from xanthan gum, Guar gum, Gum acacia, cellulose gum.

In some embodiments, the composition includes at least one pre-biotic fiber. The pre-biotic fiber source includes fructo-oligosaccharides and inulin.

In some embodiments, at least one carbohydrate source comprises includes cereals, legumes, and fibers sources including inulin and gum acacia.

In some embodiments, at least one protein source includes whey protein concentrate, milk protein concentrate, soy protein concentrate, defatted soybean flour, soy protein isolate, and pea protein concentrate.

In some embodiments, at least one dietary fiber includes inulin, fructo-oligosaccharides and gum acacia.

In some embodiments, at least one fat source is selected from rice bran oil, sunflower oil.

In some embodiments, the mineral premix includes calcium, phosphorus, magnesium, iron, zinc, and copper. The source of the mineral premix includes tri-calcium phosphate, magnesium oxide, ferric pyrophosphate, zinc sulfate monohydrate, copper gluconate.

In some embodiments, the vitamin premix includes vitamin A, vitamin B1, vitamin B2, vitamin B3, vitamin B6, vitamin B9, vitamin B12, vitamin C, vitamin E, and vitamin K. A source of the vitamin premix includes retinyl acetate, thiamine hydrochloride, riboflavin, nicotinamide, pyridoxine hydrochloride, n-pteroyl-1-glutamic acid, cyanocobalamin, ascorbic acid, ergocalciferol, alpha-tocopherol acetate, phylloquinone.

In some embodiments, the composition is in a form of a ready-to-mix beverage powder, a liquid concentrate, a solid formulate, wherein the solid formulate comprises at least one of a tablet, biscuit, granulate.

In some embodiments, a single serving of the composition includes about 30 grams of the composition provides 11-12 grams of protein, 3-3.3 grams of dietary fiber, 900-1200 mg of monounsaturated fatty acids, 600 to 1200 mg of polyunsaturated fatty acid, 600-1200 mg of saturated fat, 15 to 55% of recommended daily intake of vitamins, and 15 to 55% of recommended daily intake of minerals.

In some embodiments, the single serving of the composition comprising about 30 grams of the composition provides 12 grams of protein, greater than 3-3.3 grams of dietary fiber, 900 to 1200 mg of monounsaturated fatty acids, 600-1200 mg of polyunsaturated fatty acid, 600-1200 mg of saturated fat, 15 to 55% of recommended daily intake of vitamins, and 15 to 55% of recommended daily intake of minerals.

According to a second aspect, a method of preparing a nutritional supplement composition with a recommended nutrient profile for the geriatric population is provided. The method includes the steps of: (i) blending at least one carbohydrate source, at least one protein source, and at least one dietary fiber together with a fat source in a blender to obtain a first homogenous mixture, (ii) adding water to the first homogenous mixture to form a slurry, (iii) passing the slurry through a sieve to remove lumps in the slurry, (iv) spray drying the slurry, (v) adding a mineral premix, a vitamin premix, a flavoring agent, a coloring agent, and a sweetener with the spray-dried mixture to form a second homogenous mixture, (vi) agglomerating the second homogenous mixture, and (vi) drying the agglomerated second homogenous mixture to produce the nutrient supplement composition. The method includes (i) blending at least one carbohydrate source, at least one protein source, at least one dietary fiber, and at least one fat source for about 30 minutes in the blender to obtain the first homogenous mixture. The fat source is added slowly into the blender to produce the first homogenous mixture. (ii) adding water to the first homogenous mixture in a ratio of 1:4 to produce the slurry, (iii) spray drying the slurry at an inlet air temperature of about 180-190° C. and an outlet air temperature of about 70-75° C., (iv) agglomerating the second homogenous mixture at about 7 rpm to about 10 rpm, wherein the agglomeration is performed at an inlet air temperature of about 50° C. to 55° C. and an outlet air temperature of 20° C., (v) drying the agglomerated second homogenous mixture to a predetermined temperature of about 55° C. to 60° C. for about 15-20 min to produce the nutrient supplement composition.

In some embodiments, the slurry is introduced at a flow rate of about 25 to 30 ml/minute with an air pressure of about 2.0 to 3.0 Kg/cm² for spray drying.

In some embodiments, the agglomeration is performed at an air pressure of about 2-2.5 Kg/cm² and about 20 to 25% moisture.

### BRIEF DESCRIPTION OF THE DRAWINGS

The embodiments herein will be better understood from the following detailed descriptions with reference to the drawings, in which:

FIG. 1 illustrates a nutrient supplement composition with a recommended nutrient profile for the geriatric population according to some embodiments herein; and

FIGS. 2A and 2B illustrate a method of producing a nutrient supplement composition with a recommended nutrient profile for the geriatric population according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

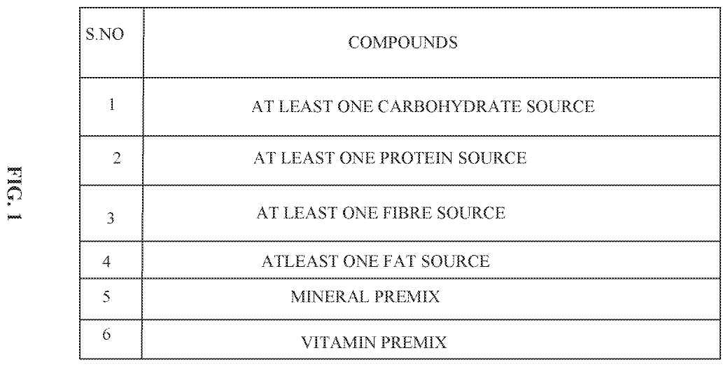

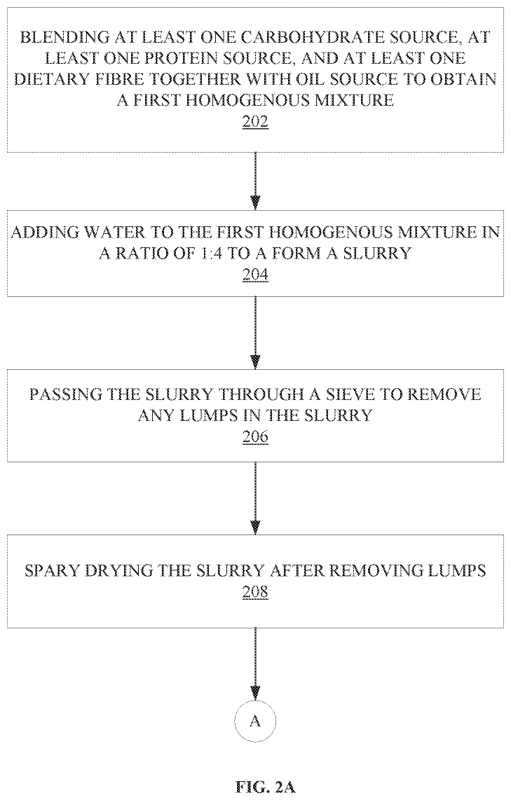

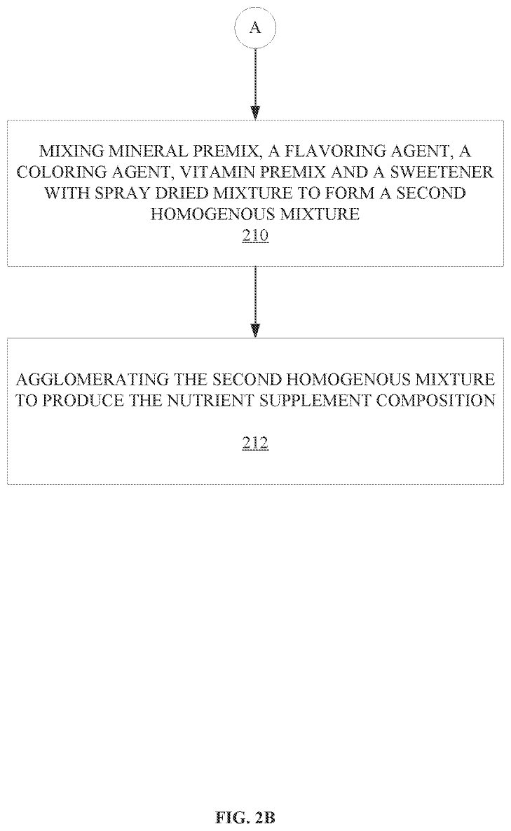

As mentioned, there remains a need for a nutrient supplement to satisfy the daily nutritional requirements of the geriatric population. The embodiments herein achieve this by providing a nutrient supplement composition specifically for the geriatric population and a method of preparing the nutrient supplement composition. Referring now to the drawings and more particularly to FIGS. 1 through 2A, 2B, where similar reference characters denote corresponding features consistently throughout the figures, there are shown preferred embodiments.

The nutrient supplement composition meets the nutritional needs of the geriatric population in a sustained manner. The nutrient supplement composition is also suitable for adults. The nutrient supplement composition, according to the embodiments herein, is rich in fiber which is essential for people with metabolic syndrome. Fiber intake is considered an important factor for healthy aging. Further, the nutrient supplement composition delivers all the essential amino acids (EAA), making it a complete source of protein. Aging is associated with sarcopenia condition, which is associated with progressive loss of muscle mass that increases the risk of injury and disability. EAA is key for muscle protein synthesis in aged people. The nutrient supplement composition also delivers key micronutrients that are needed for energy and protein metabolism. The nutrient supplement composition delivers essential nutrients in one meal and aid to bridge the gap in nutrient intake. The nutrient supplement composition is devoid of any added sugar, artificial sweetener and delivers less than 10% energy coming from saturated fat making the nutrient supplement composition ideal for the geriatric population.

FIG. 1 illustrates a nutrient supplement composition, according to some embodiments herein. The nutrient supplement composition includes (i) at least one carbohydrate source, (ii) at least one protein source, (iii) at least one dietary fiber, (iv) at least one fat source, (v) mineral premix, and (vi) vitamin premix. The composition includes about, 18%-34% w/w of at least one carbohydrate source, 48%-57% w/w of the at least one protein source, (iii) 8%-21% w/w of at least one dietary fiber, (iv) 5%-9% w/w of the at least one fat source, 4.0% w/w of the mineral premix, and 0.16% w/w of the vitamin premix.

The nutrient supplement composition may include (i) 27%-34% weight/weight (w/w) of at least one carbohydrate source, (ii) 49%-57% w/w of at least one protein source, (iii) 8%-12% w/w of at least one dietary fibre, (iv) 6%-9% w/w of at least one fat source, (v) 4.0% w/w of mineral premix, and (vi) 0.16% w/w of vitamin premix. The nutrient supplement composition may be a combination of cereal, legume, and dairy-based protein concentrates along with the dietary fiber, the fat source, minerals, and vitamins.

The nutrient supplement composition may include (i) 18%-22% weight/weight (w/w) of at least one carbohydrate source, (ii) 48%-56% w/w of at least one protein source, (iii) 14.7%-21% w/w of at least one dietary fibre, (iv) 5%-8% w/w of fat source, (v) 4% w/w of mineral premix, and (vi) 0.16% w/w of vitamin premix. The nutrient supplement composition includes 0.1%-0.7% w/w of stabilizer. The nutrient supplement composition may be a combination of legume-based protein concentrates along with the dietary fiber, the fat source, minerals, and vitamins.

The nutrient supplement composition may include 0.08% w/w of a sweetener. The sweetener may be stevia. The nutrient supplement composition may include 0.5% w/w of a coloring agent. The coloring agent may be selected from turmeric powder, beetroot, caramel, annatto. and 0.5%-2% w/w of at least one flavoring agent. The flavoring agent may be a natural flavoring agent, nature-identical flavoring agent, or artificial flavoring agent. The natural flavoring agent may be selected from badam powder, Kesar badam powder, cardamom powder, saffron powder. These flavoring agents or coloring agents may be natural or synthetic. It will be understood that any of the flavoring agents and coloring agents in any of the disclosed formulations may be exchanged with any other flavoring agents or coloring agents. In addition, flavor modifiers such as flavor masking agents may be used to adjust the taste of the nutrient supplement composition to suit a particular flavor profile.

The nutrient supplement composition may include 0.1%-0.7% w/w of stabilizer. The stabilizer may be selected from xanthan gum, Guar gum, Gum acacia, cellulose gum.

The nutrient supplement composition may include at least one pre-biotic. The pre-biotic comprises Fructo-oligosaccharides and Inulin.

At least one carbohydrate source may include cereals, legumes, and fructooligosaccharides. The cereals include whole wheat flour, barley and rice flour. The protein source includes whey protein concentrate, milk protein concentrate, soy protein concentrate, defatted soybean flour, soy protein isolate, and pea protein concentrate. The combination of cereals, legumes, and protein sources delivers all essential amino acids that include branched-chain amino acids (BCAAs). The BCAAs include leucine, isoleucine, and valine which help in muscle protein synthesis in the geriatric population.

The dietary fiber may include inulin and gum acacia. The dietary fiber which can help to maintain good gut health for the geriatric population. The dietary fiber delivers soluble dietary fiber needed for people with metabolic syndrome. The soluble dietary fiber acts as a pre-biotic promoting good gut microflora. Total dietary fiber contributes to soluble to insoluble fiber ratio of about 2:1 in every 100 grams or 30 grams serve.

The fat source may include rice bran oil, sunflower oil. Less than 10% of energy is obtained from the saturated fat source of the nutrient supplement composition. Less than 10% of energy is obtained from the inherent sugars. The nutrient supplement composition is devoid of added sugar in any form.

The mineral premix includes calcium, phosphorus, magnesium, iron, zinc, and copper. The Source of the mineral premix includes tricalcium phosphate, magnesium oxide, ferric pyrophosphate, zinc sulfate monohydrate, and copper gluconate. The mineral premix plays a role in the formation of healthy bones, structural role in nucleic acids, energy production and metabolism, healthy blood formation, and boosting the immune system.

The vitamin premix includes vitamin A (Retinol), vitamin B1 (Thiamine), vitamin B2 (Riboflavin), vitamin B3 (Niacin), vitamin B6 (Pyridoxine), vitamin B9 (Folic Acid), vitamin B12 (Cobalamine), vitamin C (Ascorbic acid), vitamin E (Tocopherols), and vitamin K. Source of the vitamin premix includes retinyl acetate, thiamine hydrochloride, riboflavin, nicotinamide, pyridoxine hydrochloride, n-pteroyl-1-glutamic acid, cyanocobalamin, ascorbic acid, alpha-tocopherol acetate, and phylloquinone. The vitamin premix plays a major role in healthy vision, boosting immunity, carbohydrate, protein, and fat metabolism, energy release from foods, and antioxidant function.

The nutrient supplement composition may be in a form of a ready-to-mix beverage powder which is mixed with water, milk, or other fluid to form an aqueous solution or mixture at the time of consumption. The nutrient supplement composition may be in a form of liquid formulation, a liquid concentrate, or a solid form (such as, but not limited to, tablets, a powder, granulate, or solid concentrate), in which case the nutrient supplement composition is mixed with the water, the milk, or other fluid to form the aqueous solution or mixture at the time of consumption. The nutrient supplement composition may be in the form of biscuits, porridges, or soups. Regardless of a physical form, the nutrient supplement composition, whether in liquid or solid form, are stable for extended periods at ambient condition.

In some embodiments, the nutrient supplement composition includes 14%-18% w/w of wheat flour, 2.0%-3.0% w/w of rice flour, 3%-6.5% w/w of barely flour, 11%-15.4% of whey protein concentrate, 14%-16% w/w of milk protein concentrate, 10%-13% of w/w of defatted soy bean flour, 8.5%-15% w/w of soy protein isolate, 6%-8% w/w of inulin, 2%-4% w/w of gum acacia, 6%-9% w/w of rice bran oil, 4% w/w of mineral premix, 0.16% w/w of vitamin premix, 0.08% w/w of stevia, 0.3%-0.5% w/w of turmeric powder, and 0.3%-0.6% w/w of kesar badam flavor.

In some embodiment, the nutrient supplement composition includes 14%-18% w/w of wheat flour, 2%-5% w/w of rice flour, 3%-6.5% w/w of barely flour, 11%-15.4% of whey protein concentrate, 14%-16% w/w of milk protein concentrate, 10%-13% of w/w of defatted soy bean flour, 8.5%-15% w/w of soy protein isolate, 6%-8% w/w of inulin, 2%-4% w/w of gum acacia, 6%-9% w/w of rice bran oil, 4% w/w of mineral premix, 0.16% w/w of vitamin premix, 0.08% w/w of stevia, 1%-2% w/w of badam powder, and 0.5%-1% w/w of cardamom powder.

In some embodiments, the vitamin premix includes 148.1 μg of retinyl acetate, 0.3 mg of thiamine hydrochloride, 0.38 mg of riboflavin, 3.6 mg of nicotinamide, 0.46 mg of pyridoxine hydrochloride, 90.6 μg of n-pteroyl-1-glutamic acid, 0.9 μg of cyanocobalamin, 12.6 mg of ascorbic acid, 2.7 mg of alpha-tocopherol acetate, and 23.9 μg of phylloquinone.

An individual serving of the nutrient supplement composition (i.e., a combination of cereal, legume, with dairy-based protein concentrates) delivers 12 grams (g) of protein (20% of recommended dietary allowances (RDA) of high-quality protein), 3.0-3.3 g of total dietary fiber, all essential amino acids with zero added sugar, less than 10% energy from saturated fatty acids which are known to be unhealthy for human health, and less than 10% of the energy obtained from inherent sugars. The nutrient supplement composition delivers in one serving good fats i.e., 900-1200 mg of monounsaturated fatty acids and 600 to 1200 mg of polyunsaturated fatty acid. The nutrient supplement composition delivers in one serving less than 1 g of lactose and 600-1200 mg of saturated fat. The nutrient supplement composition delivers in one serving 30% of recommended daily intake of Vitamins A, B1, B2, B3, B6, B9, B12, C, E, and K and Minerals i.e., Calcium, Phosphorus, Magnesium, Iron, Zinc and Copper as per Indian Council of Medical Research (ICMR)-National Institute of Nutrition, India (NIN) 2020.

Table 1 shows a nutritional profile of the nutrient supplement composition per 100 g according to some embodiments herein.

TABLE 1

| Nutritional Information | Per 100 g (Nutritional Information) |
|---|---|
| Energy (kilocalorie, kcal) | 380-400 |
| Total Carbohydrates (gram, g) | 36-42 |
| Added Sugar | 0-0.0 |
| Total Sugars (g) | 4-6 |
| Dietary Fibre (g) | 10-15 |
| Protein (g) | 39-42 |
| Total Fat (g) | 8-11 |
| Saturated Fatty Acid (g) | 2-4 |
| Monounsaturated Fatty Acid (g) | 3-4 |
| Polyunsaturated Fatty Acid (g) | 2-4 |
| Trans Fat (g) | 0.1 or lower |

Table 2 shows a nutritional profile of micronutrients (Minerals Premix and Vitamin Premix) per serving of the composition comprising about 30 grams of the composition according to some embodiments herein.

| | |
|---|---|
| Minerals Premix | Calcium (180-250 mg) Phosphorus (180-340 mg), |
| | Magnesium (102-140 mg), Iron (8-10 mg), |
| | Zinc (4-5 mg), Copper (0.5-1 mg) |
| Vitamin Premix | Vitamin A (148-180 μg), Vitamin B1 (0.3-0.4 mg), |
| | Vitamin B2 (0.35-0.4 mg), Vitamin B3 |
| | (3.5-4.5 mg), Vitamin B6 (0.45-0.5 mg), |
| | Vitamin B9 (85-95 μg), Vitamin B12 |
| | (0.7-0.9 μg), Vitamin C (12-15 mg), Vitamin E |
| | (2.5-4.5 mg), Vitamin K (16.5-28 μg). |

Table 3 shows a nutritional profile of the nutrient supplement composition with analyzed values Per 100 g according to some embodiments herein.

TABLE 3

| Nutritional Information | Per 100 g (Analyzed values) |
|---|---|
| Energy (kilocalorie, kcal) | 380.02 |
| Total Carbohydrates (gram, g) | 47.71 |
| Added Sugar | 0 |
| Total Sugars (g) | 4.4 |
| Dietary Fibre (g) | 10.73 |
| Protein (g) | 40.01 |
| Total Fat (g) | 8.36 |
| Saturated Fatty Acid (g) | 2.84 |
| Monounsaturated Fatty Acid (g) | 3.06 |
| Polyunsaturated Fatty Acid (g) | 2.54 |
| Trans Fat (g) | <0.1 |

Table 4 shows a nutritional profile of micronutrients (Minerals Premix and Vitamin Premix) per serving of the composition comprising about 30 grams of the composition according to some embodiments herein.

| | |
|---|---|
| Minerals Premix | Calcium (240.8 mg) Phosphorus |
| | (332.7 mg), Magnesium (130.5 mg), Iron |
| | (8.9 mg), Zinc (4.5 mg), Copper (0.9 mg) |
| Vitamin Premix | Vitamin A (148.1 μg), Vitamin B1 |
| | (0.3 mg), Vitamin B2 (0.38 mg), Vitamin B3 |
| | (3.6 mg), Vitamin B6 (0.46 mg), Vitamin B9 |
| | (90.6 μg), Vitamin B12 (0.9 μg), Vitamin C |
| | (12.6 mg), Vitamin E (2.7 mg), Vitamin K |
| | (23.9 μg). |

Table 5 shows a nutritional profile of the nutrient supplement composition according to some embodiments herein.

| S. No. | Ingredients | Composition (%) |
|---|---|---|
| 1. | Soy protein isolate | 8.5 |
| 2. | Whey Protein Concentrate | 15.44 |
| 3. | Milk Protein Concentrate | 15 |
| 4. | Brown Rice | 2.473 |
| 5. | Defatted Soya flour | 11 |
| 6. | Barely | 6.32 |
| 7. | Whole Wheat Flour | 18 |
| 8. | Rice bran oil | 6 |
| 9. | Inulin | 6 |
| 10. | Vitamin Premix | 0.167 |
| 11. | Mineral Premix | 4 |
| 12. | Stevia | 0.08 |
| 13. | Tapioca Dextrin | 3 |
| 14. | Gum Acacia Soluble Fiber | 3.02 |
| 15. | Turmeric Powder | 0.5 |
| 16. | Kesar Badam Flavor | 0.5 |
| 17. | Total Formulation (g) | 100 |

An individual serving of the nutrient supplement composition delivers 12 grams (g) of protein (20% of recommended dietary allowances (RDA) of high-quality protein), greater than 3 g of dietary fiber majorly containing soluble fiber, all essential amino acids with zero added sugar, less than 10% energy from saturated fatty acids which are known to be unhealthy for human health and less than 10% of the energy obtained from inherent sugars. The nutrient supplement composition, in one serving, delivers good fats i.e., 700-1110 mg of monounsaturated fatty acids and 600-1000 mg of polyunsaturated fatty acid. The nutrient supplement composition, in one serving, delivers less than 650 mg of saturated fat. The nutrient supplement composition, in one serving, delivers 30% of recommended daily intake of Vitamins A, B1, B2, B3, B6, B9, B12, C, E, and K and Minerals i.e., Calcium, Phosphorus, Magnesium, Iron, Zinc, Copper, as per Indian Council of Medical Research (ICMR)-National Institute of Nutrition, India (NIN) 2020.

One servings of the nutrient supplement composition deliver key daily nutritional needs for the elderly i.e., 15-55% of recommended daily requirements of vital micronutrients and 20% daily requirement of protein calculated based on ICMR 2020. This will aid in bridging the gap in nutrient intake.

FIGS. 2A and 2B illustrate a method of producing a nutrient supplement composition, according to some embodiments herein. At a step 202, at least one carbohydrate source, at least one protein source, and at least one dietary fiber are blended with a fat source to obtain a first homogenous mixture. At least one carbohydrate source, at least one protein source, and at least one dietary fiber may be blended in a blender for 30 minutes thereafter the fat source is added slowly into the blender to form the first homogenous mixture. At a step 204, water is added to the first homogenous mixture in a ratio of 1:4 to form a slurry. At a step 206, the slurry is passed through a sieve to remove any lumps in the slurry. At a step 208, the slurry, after removing lumps, is subjected to spray drying. The spray drying conditions may include an inlet air temperature: 180-190° C., an outlet air temperature: 70-75° C., flow Rate (milliliter (ml)/minute):25-30 and air pressure of a pump (Kg/cm2):2.0-3.0.

At a step 210, mineral premix, a flavoring agent, a coloring agent, vitamin premix, and a sweetener are mixed with a spray-dried mixture to form a second homogenous mixture. At a step 212, the second homogenous mixture is agglomerated. The agglomeration conditions may include 20-25% moisture, the temperature of air:50-55° C., air pressure of a pump (Kg/cm2):2-2.5, drying temperature:55-60° C., an outlet air temperature:20° C., time of drying:15-20 min and motor speed: 7-10 Revolutions per minute (RPM). At a step 214, the agglomerated second homogenous mixture is dried to produce the nutrient supplement composition.

In some embodiments, the method of producing the nutrient supplement composition includes (i) mixing at least one carbohydrate source, at least one protein source, and at least one dietary fiber are blended to obtain a first homogenous mixture, (ii) mixing mineral premix, a flavoring agent, a coloring agent, vitamin premix and a sweetener to form a second homogenous mixture, (iii) blending the first homogenous mixture and the second homogenous mixture thereafter slowly adding the fat source, to produce the nutrient supplement composition. Then, the nutrient supplement composition is packed. The first homogenous mixture and the second homogenous mixture may be mixed in a blender for about 30 minutes.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of employed herein is for the purpose of description and not of limitation. Therefore, while the embodiments herein have been described in terms of preferred embodiments, those skilled in the art will recognize that the embodiments herein can be practiced with modification within the sprit and scope of the appended claims.

What is claimed is:

1. A nutritional supplement composition with a recommended nutrient profile for geriatric population, wherein the composition comprising:
at least one carbohydrate source, at least one protein source, wherein the protein source comprises at least one essential amino acid, at least one dietary fiber, at least one fat source; a mineral premix; and a vitamin premix,
characterized by that, the composition comprises about, 18%-34% w/w of the at least one carbohydrate source; 48%-57% w/w of the at least one protein source; (iii) 8%-21% w/w of the at least one dietary fiber; (iv) 5%-9% w/w of the at least one fat source;
4.0% w/w of the mineral premix, and 0.16% w/w of the vitamin premix.

2. The nutritional supplement composition as claimed in claim 1, wherein the composition comprises about (i) 27%-34% w/w of the at least one carbohydrate source; (ii) 49%-57% w/w of the at least one protein source; (iii) 8%-12% w/w of the at least one dietary fiber; (iv) 6%-9% w/w of the at least one fat source; (v) 4.0% w/w of the mineral premix, and (vi) 0.16% w/w of the vitamin premix.

3. The nutritional supplement composition as claimed in claim 1, wherein the composition comprises about (i) 18%-22% w/w of the at least one carbohydrate source, (ii) 48%-56% w/w of the at least one protein source, (iii) 14.7%-21% w/w of the at least one dietary fiber, (iv) 5%-8% w/w of the at least one fat source, (v) 4% w/w of the mineral premix, and (vi) 0.16% w/w of the vitamin premix.

4. The nutritional supplement composition as claimed in claim 1, wherein the composition comprises 0.08% w/w of a sweetener, wherein the sweetener is stevia.

5. The nutritional supplement composition as claimed in claim 1, wherein the composition comprises 0.5% w/w of a coloring agent, wherein the coloring agent is selected from turmeric powder, beetroot, caramel, annatto.

6. The nutritional supplement composition as claimed in claim 1, wherein the composition comprises 0.5%-2% w/w of at least one flavoring agent, wherein the flavoring agent is a natural flavoring agent, nature-identical flavoring agent, or artificial flavoring agent, wherein the natural flavoring agent is selected from badam powder, Kesar badam powder, cardamom powder, saffron powder.

7. The nutritional supplement composition as claimed in claim 1, wherein the composition comprises 0.1%-0.7% w/w of stabilizer, wherein the stabilizer is selected from xanthan gum, Guar gum, Gum acacia, cellulose gum.

8. The nutritional supplement composition as claimed in claim 1, wherein the composition comprises at least one a pre-biotic, wherein the pre-biotic comprises Fructo-oligosaccharides and Inulin.

9. The nutritional supplement composition as claimed in claim 1, wherein the at least one carbohydrate source comprises cereals, legumes, and fibers sources comprising Inulin and gum acacia.

10. The nutritional supplement composition as claimed in claim 1, wherein the at least one protein source comprises whey protein concentrate, milk protein concentrate, soy protein concentrate, defatted soybean flour, soy protein isolate, and pea protein concentrate.

11. The nutritional supplement composition as claimed in claim 1, wherein the at least one dietary fiber comprises inulin, fructo-oligosaccharides and gum acacia.

12. The nutritional supplement composition as claimed in claim 1, wherein the at least one fat source is selected from rice bran oil, sunflower oil.

13. The nutritional supplement composition as claimed in claim 1, wherein the mineral premix comprises calcium, phosphorus, magnesium, iron, zinc, and copper, and wherein a source of the mineral premix comprises tri-calcium phosphate, magnesium oxide, ferric pyrophosphate, zinc sulfate monohydrate, copper gluconate.

14. The nutritional supplement composition as claimed in claim 1, wherein the vitamin premix comprises vitamin A, vitamin B1, vitamin B2, vitamin B3, vitamin B6, vitamin B9, vitamin B12, vitamin C, vitamin E, and vitamin K, wherein a source of the vitamin premix includes retinyl acetate, thiamine hydrochloride, riboflavin, nicotinamide, pyridoxine hydrochloride, n-pteroyl-1-glutamic acid, cyanocobalamin, ascorbic acid, alpha-tocopherol acetate, phylloquinone.

15. The nutritional supplement composition as claimed in claim 1, wherein the composition is in a form of a ready-to-mix beverage powder, a liquid concentrate, a solid formulate, wherein the solid formulate comprises at least one of a tablet, biscuit, granulate.

16. The nutritional supplement composition as claimed in claim 2, wherein a single serving of the composition comprising about 30 grams of the composition provides 11-12 grams of protein, 3-3.3 grams of dietary fiber, 900-1200 mg of monounsaturated fatty acids, 600 to 1200 mg of polyunsaturated fatty acid, 600-1200 mg of saturated fat, 15 to 55% of recommended daily intake of vitamins, and 15 to 55% of recommended daily intake of minerals.

17. The nutritional supplement composition as claimed in claim 3, wherein the single serving of the composition comprising about 30 grams of the composition provides 12 grams of protein, greater than 3-3.3 grams of dietary fiber, 900 to 1200 mg of monounsaturated fatty acids, 600-1200 mg of polyunsaturated fatty acid, 600-1200 mg of saturated fat, 15 to 55% of recommended daily intake of vitamins, and 15 to 55% of recommended daily intake of minerals.

18. A method of preparing a nutritional supplement composition with a recommended nutrient profile for geriatric population, wherein the method comprising the steps of: (i) blending at least one carbohydrate source, at least one protein source, and at least one dietary fiber together with a fat source in a blender to obtain a first homogenous mixture;
(ii) adding water to the first homogenous mixture to form a slurry; (iii) passing the slurry through a sieve to remove lumps in the slurry; (iv) spray drying the slurry, (v) adding a mineral premix, a vitamin premix, a flavoring agent, a coloring agent, and a sweetener with the spray-dried mixture to form a second homogenous mixture; (vi) agglomerating the second homogenous mixture; and (vi) drying the agglomerated second homogenous mixture to produce the nutrient supplement composition,
Characterized by that,
blending the at least one carbohydrate source, at least one protein source, at least one dietary fiber, and at least one fat source for about 30 minutes in the blender to obtain the first homogenous mixture, wherein the fat source is added slowly into the blender to produce the first homogenous mixture;
adding water to the first homogenous mixture in a ratio of 1:4 to produce the slurry;
spray drying the slurry at an inlet air temperature of about 180-190° C. and an outlet air temperature of about 70-75° C.;
agglomerating the second homogenous mixture at about 7 rpm to about 10 rpm, wherein the agglomeration is performed at an inlet air temperature of about 50° C. to 55° C. and an outlet air temperature of 20° C.;
drying the agglomerated second homogenous mixture to a predetermined temperature of about 55° C. to 60° C. for about 15-20 min to produce the nutrient supplement composition.

19. The method as claimed in claim 18, wherein the slurry is introduced at a flow rate of about 25 to 30 ml/minute with an air pressure of about 2.0 to 3.0 Kg/cm2 for spray drying.

20. The method as claimed in claim 18, wherein the agglomeration is performed about at an air pressure of about 2-2.5 Kg/cm2 and about 20 to 25% moisture.
